(19) United States
(12) Patent Application Publication
(10) Pub. No.: US 2026/0184037 A1
(43) Pub. Date: Jul. 2, 2026

(54) METAL COMPOSITE SUBSTRATE

(71) Applicant: COMPAL ELECTRONICS, INC., Taipei City (TW)

(72) Inventors: Chih-Hua Liu, Taipei City (TW); Jung-Chin Wu, Taipei City (TW); Han-Ching Huang, Taipei City (TW); Yung-Hui Chen, Taipei City (TW)

(73) Assignee: COMPAL ELECTRONICS, INC., Taipei City (TW)

(21) Appl. No.: 19/260,247

(22) Filed: Jul. 3, 2025

Related U.S. Application Data
(60) Provisional application No. 63/718,725, filed on Nov. 10, 2024.
(60) Provisional application No. 63/763,920, filed on Feb. 27, 2025.

(51) Int. Cl. B32B 3/30; B32B 7/12; B32B 15/08

(52) U.S. Cl. CPC B32B 3/30; B32B 7/12; B32B 15/08; B32B 2250/03; B32B 2307/402; B32B 2307/7376

(57) ABSTRACT

A metal composite substrate suitable for forming a casing through stamping and bending is provided. The metal composite substrate includes a metal layer, an adhesive layer, and an appearance decoration layer. The metal layer has a first surface, a second surface opposite to the first surface, and a groove recessed in the first surface. The adhesive layer is disposed on the second surface. The appearance decoration layer is disposed on the adhesive layer and is attached to the metal layer through the adhesive layer. The casing formed from the metal composite substrate by stamping and bending has a bending chamfer, which includes a bending outer angle and a bending inner angle. A positive draft angle or a negative draft angle is formed at the bending outer angle, and the groove is located at the bending inner angle.

### CROSS-REFERENCE TO RELATED APPLICATION

This application claims the priority benefit of U.S. provisional application Ser. No. 63/718,725, filed on Nov. 10, 2024, and U.S. provisional application Ser. No. 63/763,920, filed on Feb. 27, 2025. The entirety of each of the above-mentioned patent applications is hereby incorporated by reference herein and made a part of this specification.

### BACKGROUND

### Technical Field

The disclosure relates to a substrate, and in particular to a metal composite substrate.

### Related Art

Metal casings commonly found in electronic products are usually formed from metal substrates by stamping and bending. During processes of stamping and bending, cracks may occur due to insufficient material ductility, improper design of bending radius or direction, or excessive stamping speed, which may cause excessive stress on the bending portions. Such cracks not only cause appearance defects in the casing, but also lead to delamination between a metal layer and a decoration layer, and even weaken the structural strength and durability of the casing.

### SUMMARY

The disclosure provides a metal composite substrate which helps improve appearance quality, structural reliability, and structural strength of a manufactured casing.

The disclosure provides a metal composite substrate suitable for forming a casing through stamping and bending. The metal composite substrate includes a metal layer, an adhesive layer, and an appearance decoration layer. The metal layer has a first surface, a second surface opposite to the first surface, and a groove recessed in the first surface. The adhesive layer is disposed on the second surface. The appearance decoration layer is disposed on the adhesive layer and is attached to the metal layer through the adhesive layer. The casing formed from the metal composite substrate by stamping and bending has a bending chamfer, and the bending chamfer includes a bending outer angle and a bending inner angle. A positive draft angle is formed at the bending outer angle, and the groove is located at the bending inner angle. The bending outer angle has a radius of R1, and the positive draft angle has an angle of A1. The bending outer angle has an arc length of AL1, and AL1=(90°−|A1|)×π×R1÷180°.

In an embodiment of the disclosure, the groove has a width of W1, and W1≥0.9×AL1.

In an embodiment of the disclosure, 0°≤A1≤30°.

In an embodiment of the disclosure, the metal layer has a thickness of T1, and the groove has a depth of D1. A spacing between a bottom of the groove and the second surface is T2, where T2=(T1−D1), and R1≥T2.

In an embodiment of the disclosure, the bending inner angle has a radius of R2, and R2≥0.1×T2.

In an embodiment of the disclosure, the appearance decoration layer includes a color layer disposed on the adhesive layer and a pattern layer disposed on the color layer, and the color layer is located between the pattern layer and the adhesive layer.

In an embodiment of the disclosure, after the metal composite substrate forms the casing through stamping and bending, a reinforcement layer is formed on the first surface. The reinforcement layer is disposed on the first surface and is embedded in the groove.

In an embodiment of the disclosure, the bending chamfer is a bending fillet.

The disclosure provides a metal composite substrate suitable for forming a casing through stamping and bending. The metal composite substrate includes a metal layer, an adhesive layer, and an appearance decoration layer. The metal layer has a first surface, a second surface opposite to the first surface, and a groove recessed in the first surface. The adhesive layer is disposed on the second surface. The appearance decoration layer is disposed on the adhesive layer and is attached to the metal layer through the adhesive layer. The casing formed from the metal composite substrate by stamping and bending has a bending chamfer, and the bending chamfer includes a bending outer angle and a bending inner angle. A negative draft angle is formed at the bending outer angle, and the groove is located at the bending inner angle. The bending outer angle has a radius of R11, and the angle of the negative draft angle has an angle of A11. The bending outer angle has an arc length of AL11, and AL11=(90°+|A11|)×π×R11÷180°.

In an embodiment of the disclosure, the groove has a width of W1, and W1≥0.9×AL11.

In an embodiment of the disclosure, −30°≤A11≤0°.

In an embodiment of the disclosure, the metal layer has a thickness of T1, and the groove has a depth of D1. The spacing between the bottom of the groove and the second surface is T2, where T2=(T1−D1), and R11≥T2.

In an embodiment of the disclosure, the bending inner angle has a radius of R21, and R21≥0.1×T2.

Based on the above, the metal composite substrate of the disclosure has the groove in the metal layer to enhance the ductility of the bending portion during stamping and bending. The groove effectively disperses the internal stress generated during the bending process, preventing crack formation at the bending portion due to excessive stress, thereby achieving purposes of improving the appearance quality, structural reliability, and structural strength of the manufactured casing.

To make the above features and advantages of the disclosure more comprehensible, embodiments are specifically provided below and described in detail in conjunction with the accompanying drawings as follows.

### BRIEF DESCRIPTION OF THE DRAWINGS

FIG. 1A to FIG. 1C are cross-sectional schematic diagrams of a process of forming a casing by stamping and bending a metal composite substrate according to an embodiment of the disclosure.

FIG. 1D is a partial enlarged cross-sectional schematic diagram of FIG. 1A corresponding to a part where a groove is located.

FIG. 2 is a cross-sectional schematic diagram of another embodiment of a casing formed from the metal composite substrate in FIG. 1A by stamping and bending.

FIG. 3 is a cross-sectional schematic diagram of yet another embodiment of a casing formed from the metal composite substrate in FIG. 1A by stamping and bending.

### DESCRIPTION OF THE EMBODIMENTS

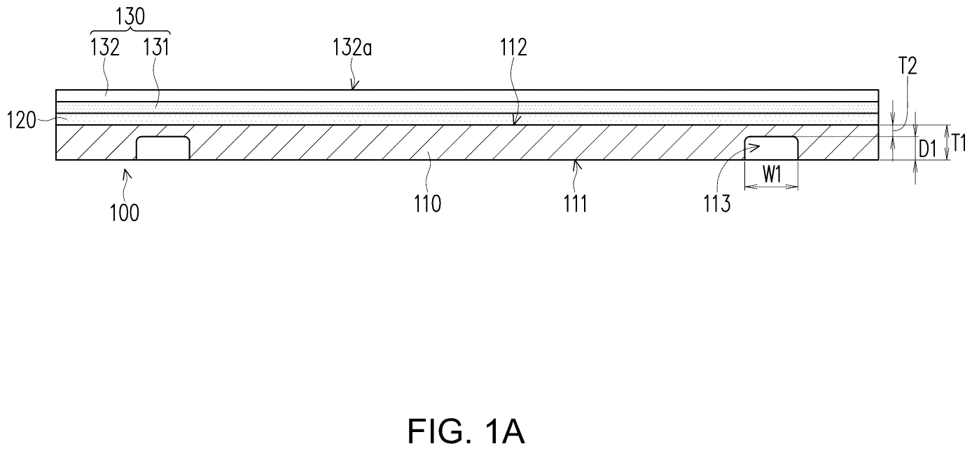

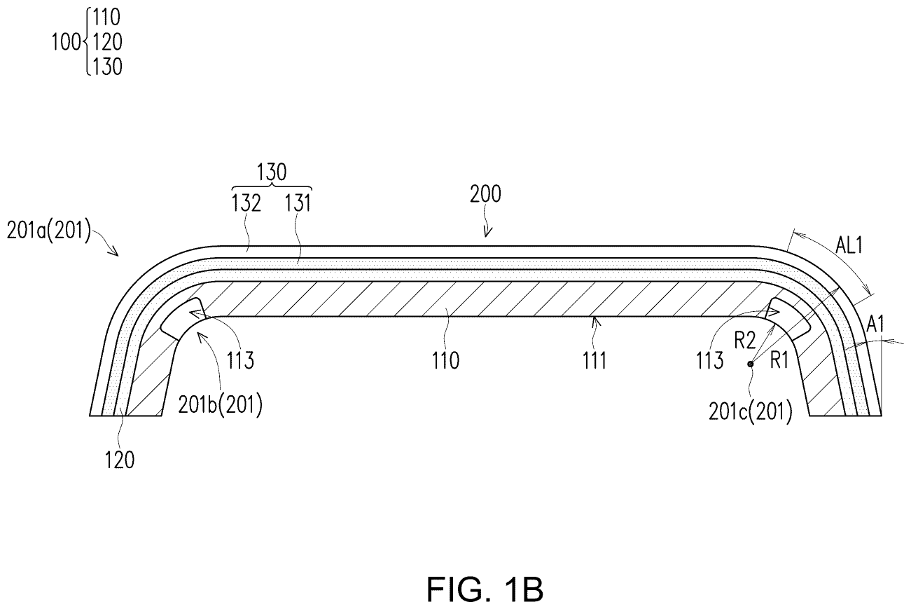

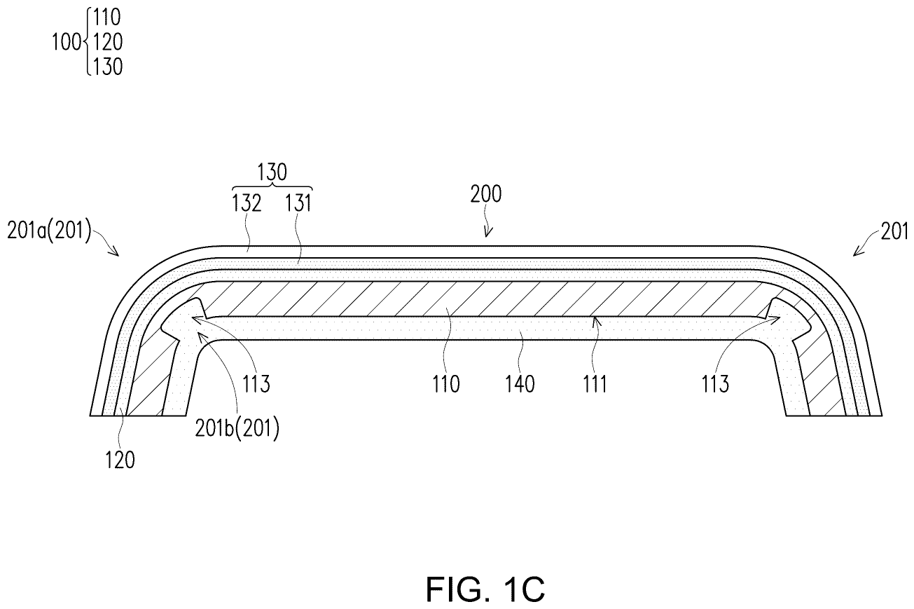

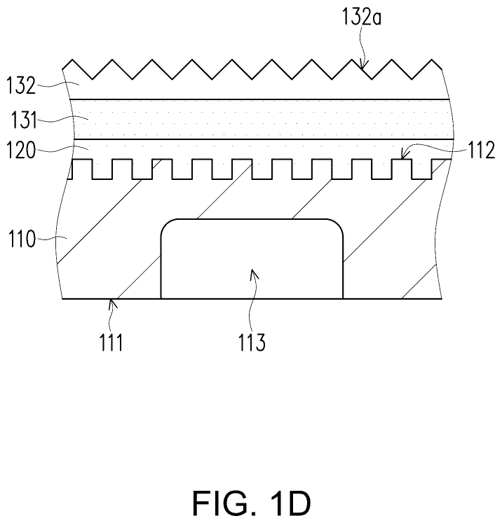

FIG. 1A to FIG. 1C are cross-sectional schematic diagrams of a process of forming a casing by stamping and bending a metal composite substrate according to an embodiment of the disclosure. FIG. 1D is a partial enlarged cross-sectional schematic diagram of FIG. 1A corresponding to a part where a groove is located. In this embodiment, referring to FIG. 1A, a metal composite substrate 100 includes a metal layer 110, an adhesive layer 120, and an appearance decoration layer 130. The metal layer 110 may be a metal sheet made of aluminum alloy, magnesium alloy, titanium alloy, stainless steel, or galvanized steel plate, and has a first surface 111, a second surface 112 opposite to the first surface 111, and a groove 113 recessed in the first surface 111.

The adhesive layer 120 is disposed on the second surface 112 of the metal layer 110, and may be formed by coating adhesive materials such as acrylic resin, polyurethane resin, epoxy resin, or polyisocyanate on the second surface 112 of the metal layer 110. In another aspect, the appearance decoration layer 130 is disposed on the adhesive layer 120, and is attached to the metal layer 110 through the adhesive layer 120, for example, by being closely attached to the metal layer 110 through a heat pressing process.

In detail, the appearance decoration layer 130 includes a color layer 131 disposed on the adhesive layer 120 and a pattern layer 132 disposed on the color layer 131, and the color layer 131 is located between the pattern layer 132 and the adhesive layer 120. For example, the composition of the color layer 131 may include acrylic resin, polyurethane resin, polyamide resin, or combinations thereof, while the composition of the pattern layer 132 may include unsaturated polyester, epoxy acrylate, polyurethane acrylate, polyester acrylate, or combinations thereof.

Referring to FIG. 1A and FIG. 1D, the second surface 112 of the metal layer 110 may be a smooth plane, or a surface with embossed texture. For example, geometric patterns or hairline texture may be formed on the second surface 112 through methods such as laser processing, mechanical grinding, or chemical etching. In another aspect, the appearance surface 132a of the pattern layer 132 relative to the color layer 131 may be a smooth plane, or a surface with embossed texture. For example, geometric patterns or hairline texture may be formed on the appearance surface 132a through methods such as transfer printing, rolling, laser processing, or chemical etching.

Furthermore, the embossed texture formed on the second surface 112 of the metal layer 110 may present visual effects with texture and light-shadow variations, while enhancing the bonding force of the adhesive layer 120 to prevent interlayer delamination. The embossed texture formed on the appearance surface 132a of the color layer 131 may present visual effects with texture and light-shadow variations and provide users with delicate and smooth tactile sensation. In another aspect, through the coordination of the pattern layer 132, the color layer 131, and the metal layer 110, metallic luster with depth and layered variations may be presented.

For example, a thickness of the metal layer 110 may be between 0.4 mm to 1.2 mm, and a thickness of the adhesive layer 120 may be between 1 mm to 20 mm. Additionally, a thickness of the color layer 131 may be between 1 mm to 10 mm, and a thickness of the pattern layer 132 may be between 1 mm to 30 mm.

Referring to FIG. 1A and FIG. 1B, stamping and bending are performed on the metal composite substrate 100, and substantially bending is performed on a part where the groove 113 in the metal layer 110 is located. In detail, the design of the groove 113 helps to enhance the ductility of the bending portion. The groove 113 effectively disperses the internal stress generated during the bending process, preventing crack formation at the bending portion due to excessive stress, thereby achieving purposes of improving the appearance quality, structural reliability, and structural strength of the casing 200 obtained through a process of manufacturing.

As shown in FIG. 1B, the casing 200 formed from the metal composite substrate 100 by stamping and bending has a bending chamfer 201. The bending chamfer 201 may be a bending fillet and include a bending outer angle 201a and a bending inner angle 201b. A positive draft angle is formed at the bending outer angle 201a, and the groove 113 is located at the bending inner angle 201b.

The bending outer angle 201a has a radius of R1, and the positive draft angle has an angle of A1. Additionally, the bending outer angle 201a has an arc length of AL1 and conforms to a following conditional expression: AL1=(90°−|A1|)×π×R1÷180°, preventing the crack formation at the bending portion due to excessive stress caused by improper design of bending radius. For example, the angle A1 of the positive draft angle conforms to a following numerical range: 0°≤A1≤30°.

As shown in FIG. 1A and FIG. 1B, the groove 113 has a width of W1, and conforms to a following relational expression: W1≥0.9×AL1.

In another aspect, the metal layer 110 has a thickness of T1, and the groove 113 has a depth of D1. A spacing between a bottom of the groove 113 and the second surface 112 is T2, and the bending inner angle 201b has a radius of R2. Furthermore, the spacing between the bottom of the groove 113 and the second surface 112 is substantially equal to the difference between the thickness of the metal layer 110 and the depth of the groove 113, thus conforming to a following conditional expression: T2=(T1−D1).

Since a bending center 201c of the bending chamfer 201 is located on a side where the bending inner angle 201b is situated, the radius of the bending outer angle 201a, the spacing between the bottom of the groove 113 and the second surface 112, and the radius of the bending inner angle 201b conform to the following relational expressions: R1≥T2, and R2≥0.1×T2, preventing the crack formation at the bending portion due to excessive stress caused by improper design of bending radius.

Refer to FIG. 1B and FIG. 1C, after the metal composite substrate 100 forms the casing 200 through stamping and bending, a reinforcement layer 140 may be formed on the first surface 111 of the metal layer 110 through methods such as hot pressing lamination or insert molding. In detail, the reinforcement layer 140 is disposed on the first surface 111 of the metal layer 110 and is embedded in the groove 113 to enhance the structural strength of the metal layer 110. For example, a material of the reinforcement layer 140 may include polycarbonate, acrylonitrile-butadiene-styrene copolymer, polypropylene, magnesium alloy, other plastic materials, or metal materials.

According to actual design requirements, a setting of the draft angles formed at the bending outer angle 201a of the bending chamfers 201 on the four sides of the casing 200 may include the following aspects: at least two sides have positive draft angles, one side has a positive draft angle and three sides have negative draft angles, or one side has a positive draft angle and three sides have draft angles of 0°.

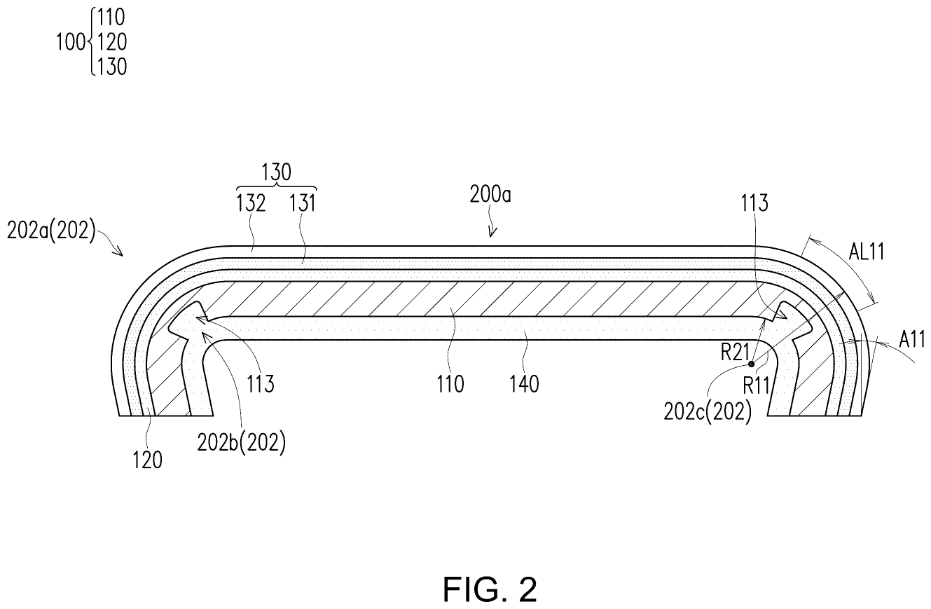

FIG. 2 is a cross-sectional schematic diagram of another embodiment of a casing formed from the metal composite substrate in FIG. 1A by stamping and bending. Referring to FIG. 1A and FIG. 2, the metal composite substrate 100 may forms a casing 200a through stamping and bending. The casing 200a has a bending chamfer 202, and the bending chamfer 202 may be a bending fillet. Additionally, the bending chamfer 202 includes a bending outer angle 202a and a bending inner angle 202b. A negative draft angle is formed at the bending outer angle 202a, and the groove 113 is located at the bending inner angle 202b.

The bending outer angle 202a has a radius of R11, and the negative draft angle has an angle of A11. Additionally, the bending outer angle 202a has an arc length of AL11, and conforms to a following conditional expression: AL11=(90°+|A11|)×π×R11÷180°, preventing the crack formation at the bending portion due to excessive stress caused by improper design of bending radius. For example, the angle A11 of the negative draft angle conforms to a following numerical range: −30°≤A11≤0°.

As shown in FIG. 1A and FIG. 1B, the groove 113 has a width of W1, and conforms to a following relational expression: W1≥0.9×AL11.

In another aspect, the metal layer 110 has a thickness of T1, and the groove 113 has a depth of D1. A spacing between the bottom of the groove 113 and the second surface 112 is T2, and the bending inner angle 202b has a radius of R21. Furthermore, the spacing between the bottom of the groove 113 and the second surface 112 is substantially equal to the difference between the thickness of the metal layer 110 and the depth of the groove 113, thus conforming to a following conditional expression: T2=(T1−D1).

Since the bending center 202c of the bending chamfer 202 is located on a side where the bending inner angle 202b is situated, the radius of the bending outer angle 202a, the spacing between the bottom of the groove 113 and the second surface 112, and the radius of the bending inner angle 202b conform to the following relational expressions: R11≥T2, and R21≥0.1×T2, preventing the crack formation at the bending portion due to excessive stress caused by improper design of bending radius.

According to actual design requirements, the setting of the draft angles formed at the bending outer angle 202a of the bending chamfers 202 on the four sides of the casing 200a may include the following aspects: at least two sides have negative draft angles, one side has a negative draft angle and three sides have positive draft angles, or one side has a negative draft angle and three sides have draft angles of 0°.

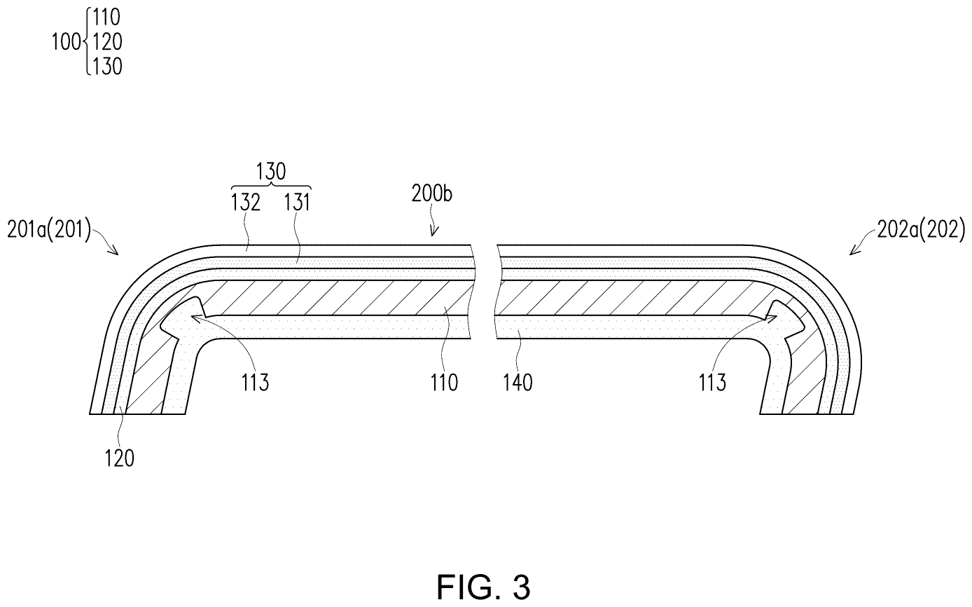

FIG. 3 is a cross-sectional schematic diagram of yet another embodiment of a casing formed from the metal composite substrate in FIG. 1A by stamping and bending. Referring to FIG. 1A and FIG. 3, the metal composite substrate 100 may form a casing 200b through stamping and bending, and at least two sides of the four sides of the casing 200b include a bending chamfer 201 having a positive draft angle formed at the bending outer angle 201a and a bending chamfer 202 having a negative draft angle formed at the bending outer angle 202a.

In summary, during the stamping and bending processes of the metal composite substrate of the disclosure, the portion where the groove in the metal layer is located is substantially bent, so that the groove is located at the bending inner angle of the bending chamfer. Furthermore, the design of the groove enhances the ductility of the bending portion and effectively disperse the internal stress generated during the bending process, preventing the crack formation at the bending portion due to excessive stress, thereby achieving the purposes of improving the appearance quality, structural reliability, and structural strength of the manufactured casing.

Although the disclosure has been disclosed above embodiments, the embodiments are not intended to limit the disclosure. Any person skilled in the art may make slight modifications and refinements without departing from the spirit and scope of the disclosure. Therefore, the protection scope of the disclosure shall be determined by the appended claims.

What is claimed is:

1. A metal composite substrate suitable for forming a casing through stamping and bending, wherein the metal composite substrate comprises:
a metal layer, having a first surface, a second surface opposite to the first surface, and a groove recessed in the first surface;
an adhesive layer, disposed on the second surface; and
an appearance decoration layer, disposed on the adhesive layer and attached to the metal layer through the adhesive layer,
wherein the casing formed from the metal composite substrate by stamping and bending has a bending chamfer, the bending chamfer comprises a bending outer angle and a bending inner angle, a positive draft angle is formed at the bending outer angle, and the groove is located at the bending inner angle, and
the bending outer angle has a radius of R1, the positive draft angle has an angle of A1, and the bending outer angle has an arc length of AL1,
wherein, AL1=(90°−|A1|)×π×R1÷180°.

2. The metal composite substrate according to claim 1, wherein the groove has a width of W1, and W1≥0.9×AL1.

3. The metal composite substrate according to claim 1, wherein 0°≤A1≤30°.

4. The metal composite substrate according to claim 1, wherein the metal layer has a thickness of T1, the groove has a depth of D1, and a spacing between a bottom of the groove and the second surface is T2, wherein T2=(T1−D1), and R1≥T2.

5. The metal composite substrate according to claim 4, wherein the bending inner angle has a radius of R2, and R2≥0.1×T2.

6. The metal composite substrate according to claim 1, wherein the appearance decoration layer comprises a color layer disposed on the adhesive layer and a pattern layer disposed on the color layer, and the color layer is located between the pattern layer and the adhesive layer.

7. The metal composite substrate according to claim 1, wherein after the metal composite substrate forms the casing through stamping and bending, a reinforcement layer is formed on the first surface, and the reinforcement layer is disposed on the first surface and is embedded in the groove.

8. The metal composite substrate according to claim 1, wherein the bending chamfer is a bending fillet.

9. A metal composite substrate suitable for forming a casing by stamping and bending, wherein the metal composite substrate comprises:
a metal layer, having a first surface, a second surface opposite to the first surface, and a groove recessed in the first surface;
an adhesive layer, disposed on the second surface; and
an appearance decoration layer, disposed on the adhesive layer and attached to the metal layer through the adhesive layer,
wherein the casing formed from the metal composite substrate by stamping and bending has a bending chamfer, the bending chamfer comprises a bending outer angle and a bending inner angle, a negative draft angle is formed at the bending outer angle, and the groove is located at the bending inner angle, and
the bending outer angle has a radius of R11, the negative draft angle has an angle of A11, and the bending outer angle has an arc length of AL11,
wherein, AL11=(90°+|A11|)×π×R11÷180°.

10. The metal composite substrate according to claim 9, wherein the groove has a width of W1, and W1≥0.9×AL11.

11. The metal composite substrate according to claim 9, wherein −30°≤A11≤0°.

12. The metal composite substrate according to claim 9, wherein the metal layer has a thickness of T1, and the groove has a depth of D1, and a spacing between a bottom of the groove and the second surface is T2, wherein T2=(T1−D1), and R11≥T2.

13. The metal composite substrate according to claim 12, wherein the bending inner angle has a radius of R21, and R21≥0.1×T2.

14. The metal composite substrate according to claim 9, wherein the appearance decoration layer comprises a color layer disposed on the adhesive layer and a pattern layer disposed on the color layer, and the color layer is located between the pattern layer and the adhesive layer.

15. The metal composite substrate according to claim 9, wherein after the metal composite substrate forms the casing through stamping and bending, a reinforcement layer is formed on the first surface, and the reinforcement layer is disposed on the first surface and is embedded in the groove.

16. The metal composite substrate according to claim 9, wherein the bending chamfer is a bending fillet.
